(19) United States
(12) Patent Application Publication
(10) Pub. No.: US 2006/0184563 A1
(43) Pub. Date: Aug. 17, 2006

(54) Method and apparatus for temporal database

(76) Inventor: David H. Potter, North Plainfield, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/057,068

(22) Filed: Feb. 14, 2005

(51) Int. Cl. G06F 7/00

(52) U.S. Cl. 707/102

(57) ABSTRACT

Methods and systems consistent with the invention store data in a database. A method or system consistent with the invention create a first record for a first time period, the first record comprising an identifier and an attribute, create a second record for a second time period, the second record comprising the identifier and the attribute, and create first information indicative of a start time and an end time of the first time period, wherein data in the attribute in the first record is valid for the first time period, and second information indicative of a start time and an end time of the second time period, wherein data in the attribute in the second record is valid for the second time period. The identifier may indicate a lineage. A method or system consistent with the invention may update the first record for the first time period by indicating in the first information that the first time period is not current, indicating in the second information that the second time period is current, and updating the attribute data in the second record for the second time period. A method or system consistent with the invention may delete a record in the second time period by indicating in the second information that the second time period is not current.

### RELATED APPLICATIONS

This application incorporates by reference the application entitled “Method and System for Searching a Database,” attorney docket 9614.0003-00, filed herewith, and “Data Search System and Method,” attorney docket 9614.0004-00, filed Feb. 11, 2005, all assigned to the same asignee.

### FIELD OF THE INVENTION

This invention relates to information management, and more particularly to a system and method for temporal databases.

### BACKGROUND OF THE INVENTION

The amount of information to be maintained continually increases in today's society. For example, in the financial industry, information on various past and present transactions of clients may need to be maintained almost indefinitely. With the need to maintain large amounts of data for a long time, data management, particularly in the area of data search, becomes increasingly difficult. Using electronic databases such as a relational database facilitates data management. But even with the use of a relational database, data management tasks such as data queries may be unreasonably cumbersome and time-consuming if the amount of data stored in the relational database is too large.

Further, electronic databases are constantly changing, with records being added, deleted, and updated. There is a need to be able to track and audit the changes to databases. For example, it may be necessary to track who made a change, why it was made, and what was changed. It may also be necessary to take a “snapshot” of the database as it existed at a particular time or over a range of times.

### SUMMARY OF THE INVENTION

Methods and systems consistent with the invention store data in a database. A method or system consistent with the invention create a first record for a first time period, the first record comprising an identifier and an attribute, create a second record for a second time period, the second record comprising the identifier and the attribute, and create first information indicative of a start time and an end time of the first time period, wherein data in the attribute in the first record is valid for the first time period, and second information indicative of a start time and an end time of the second time period, wherein data in the attribute in the second record is valid for the second time period. The identifier may indicate a lineage. A method or system consistent with the invention may update the first record for the first time period by indicating in the first information that the first time period is not current, indicating in the second information that the second time period is current, and updating the attribute data in the second record for the second time period. A method or system consistent with the invention may delete a record in the second time period by indicating in the second information that the second time period is not current.

The accompanying drawings, which are incorporated in and constitute a part of this specification, illustrate embodiments consistent with the present invention of the invention and together with the description, serve to explain the principles of the invention.

### BRIEF DESCRIPTION OF THE DRAWINGS

FIG. 1 is block diagram of a system, consistent with this invention, comprising a computer coupled to an internet;

FIG. 3 is a timeline of a database comprising three tables consistent with this invention;

FIG. 4A through 4L are a block diagrams, consistent with this invention, of query modules and data flow of a query execution;

FIG. 5 is a block diagram of a database, consistent with this invention, comprising tables for storing employee names, telephone numbers, and locations;

FIG. 6A is a timeline, consistent with this invention, of a database comprising an employee table and a telephone table;

FIG. 6B is a timeline, consistent with this invention, of a database comprising an employee table, a telephone table, and a location table;

FIGS. 7A and 7B are block diagrams, consistent with this invention, of tables in a database before and after adding an entry into the database;

FIGS. 8A and 8B are block diagrams, consistent with this invention, of tables in a database before and after updating an entry in the database;

FIGS. 9A and 9B are block diagrams, consistent with this invention, of tables in a database before and after deleting an entry in the database;

FIG. 10 is a block diagram of tables in a database, consistent with this invention, comprising an employee table and a telephone table;

FIG. 11 is a block diagram of a virtual table consistent with this invention; and

FIG. 12 is a flow diagram of a method, consistent with this invention, for searching a database.

### DESCRIPTION OF THE EMBODIMENTS

Reference is made below in detail to the present exemplary embodiments of the invention, examples of which are illustrated in the accompanying drawings. The foregoing general description and the following detailed description are exemplary and explanatory only and are not restrictive of the invention, as claimed. Wherever possible, the same reference numbers are used throughout the drawings to refer to the same or like parts.

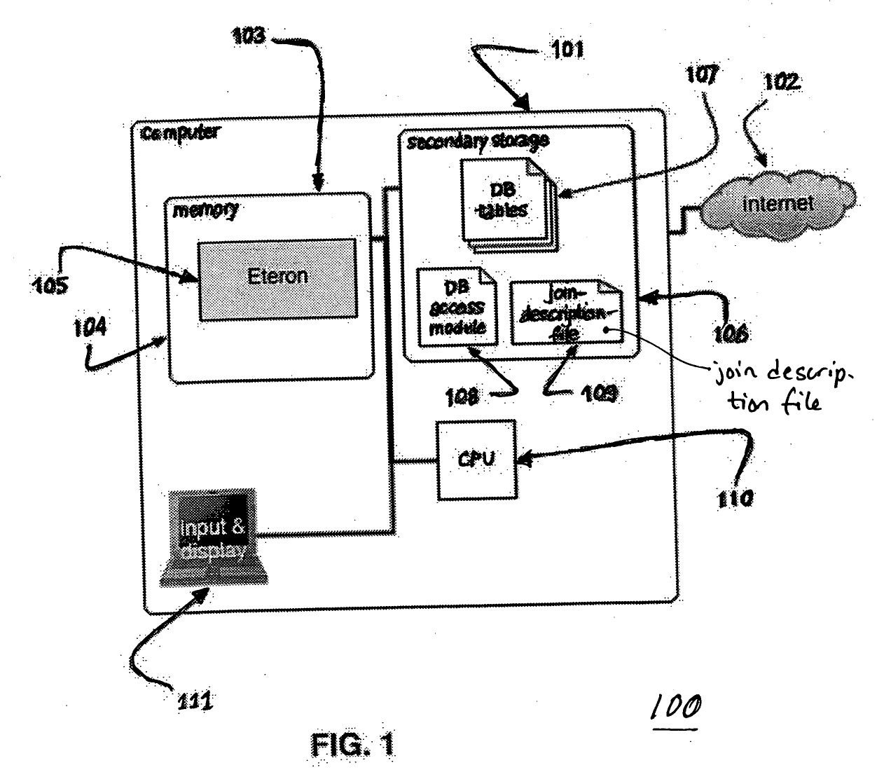

FIG. 1 is a block diagram of a system 100 consistent with this invention. System 100 comprises a computer 101 coupled to an internet 102. Computer 101 comprises an input and display device 111, a memory 103, a CPU 110, and a secondary storage device 106. Memory 104 comprises the program Eteron (TM), which is a database program that may perform methods consistent with this invention as described below. Secondary storage device 106 stores a database (DB) comprising DB tables 107, a DB access module 108, and a join-description file 109, which are described below. Other configurations of system 100 will be apparent to those of ordinary skill in the art.

A database may comprise tables, and each table may comprise records. For example, the database in secondary storage 106 comprises database tables 107. FIG. 5 is a block diagram of a database 500, consistent with this invention, comprising tables for storing employee names, telephone numbers, and locations. Database 500 comprises an employee table 502, a telephone table 512, and a location table 522. Tables 502, 512, 522, show the attribute (or field) names but not do show any records holding data. In the text below, attributes are capitalized for ease of understanding.

Employee table 502 stores employee names and corresponding employee IDs, where each record stores an employee name and an employee ID, for example, in a NAME attribute 508 and an ID attribute 510, respectively. Telephone table 512 stores employee IDs and corresponding telephone numbers, where each record stores an employee ID and a telephone number, for example, in an ID attribute 520 and a TEL attribute 518, respectively. Location table 522 stores employee IDs and corresponding employee locations, where each record stores an employee ID and an employee location, for example, in an ID attribute 530 and a STATE attribute 528.

In addition to the attributes described, each table 502, 512 and 522 also comprise a START and an END field. Employee table comprises a START field 504, an END field 506, telephone table 512 comprises a START field 514 and an END field 516, location table comprises a START field 524 and an END field 526. START field 504, for example, is indicative of a start time of a period when data in name attribute 508 of a record is valid, or “correct.” END field 506, for example, is indicative of an end time of a period when data in name attribute 508 of the record is valid.

START field 504 and END field 506 are “indicative” in that fields 504 and 506 do not have to be a time information per se (hours, minutes, seconds), but may be any information that indicates time or from which a time or time period can be derived. For example, START field 504 and END field 506 may be a hash value of the time (hours, minutes, seconds). Alternatively, START field 504 may refer to an “event table” that describes events (adding, updating, or deleting a record, for example) that occur to tables 502, 512, and 522 in database 500. The “event table” may record the time of the event.

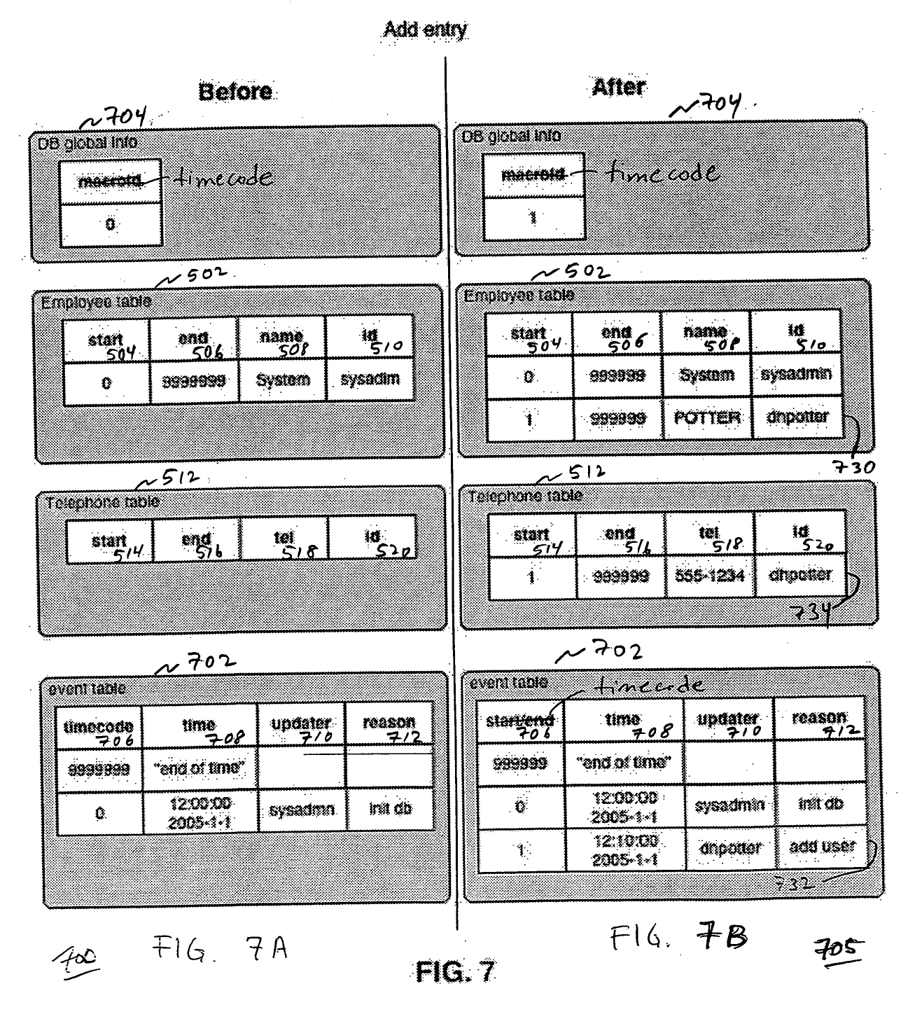

FIGS. 7A and 7B are block diagrams, consistent with this invention, of tables in a database 700 before and after adding an entry into database 700. FIGS. 7A and 7B show employee table 502 and telephone table 512 as described in FIG. 5. FIGS. 7A and 7B also show a DB global information table 704 and an event table 702. Event table 702 comprises a TIMECODE field 706, a TIME field 708, an UPDATER field 710, and a REASON field 712. Event table 702 may record events that occur to records in tables 502, 512 in database 700, for example. Events comprise, for example, adding a record to a table, deleting a record from a table, or updating a record in a table. Each record in event table 702 may describe a different event. Event table 702 allows, for example, the database to be audited, providing an auditor the identity of the person that changed the database, what changed, and why the database was changed.

UPDATER field 710 may store the employee ID of the employee that entered the event into database 700. REASON field 712 may store the reason that the event happened as explained by the employee. TIME field 708 may store the time of the event. TIMECODE field 706 may store an integer “event number.” Other fields, of course, may be added to event table 702 such as IP address, location, or supervisor of the employee entering the event. Other information may be stored in event table 702 that is useful in an audit of database 700.

In the embodiment of FIGS. 7A and 7B, TIMECODE field 706 is an integer number that increments by one for every new event. In this embodiment, the higher the timecode the later in time the event occurred. DB global info table 704 may store the last timecode used to keep track of the last timecode used. This field may also be called the NOW field because it indicates the current timecode.

To simplify the description of tables, two conventions are used. For example, second record 730 in employee table 502 in FIG. 7B may be described as follows: Second record 730 has a START of 1 an END of 999999, a NAME of POTTER an ID of dhpotter. Alternatively, the following language may be used to describe the second record: Second record 730, START is 1, END is 999999, NAME is POTTER and ID is dhpotter.

In the example of FIG. 7A and 7B a new employee is added to database 700. The new employee's name is David H. Potter, his employee id is dhpotter, and his telephone number is 555-4321. Each table 704, 502, 512, 702 appears once in FIG. 7A and once in FIG. 7B. FIG. 7A shows the state of tables 704, 502, 512, and 702 before adding the new employee information to database 700. FIG. 7B is the sate of tables 704, 502, 512, and 702 after adding new employee information to database 700. As seen in FIG. 7A, employee table 502 has one record with a NAME of System and an ID of sysadmin. As seen in FIG. 7B, employee table 502 has two records including a new employee record 730 with a NAME of POTTER and an ID of dhpotter.

Further, a new telephone record 734 is added to telephone table 512 as shown in FIG. 7B. As seen in FIG. 7A, telephone table 512 has no records. As seen in FIG. 7B, telephone table 512 has new telephone record 734 with an ID of dhpotter and TEL of 555-1234. Note that the telephone number for Mr. Potter was entered incorrectly in telephone table 512—the telephone number should have been 555-4321, not 555-1234.

Event table 702 describes the event of the addition of this new employee in an event record 732. In this embodiment, event record 732 is given a TIMECODE of 1 because this is the next integer after the integer stored in DB global info table 704 in FIG. 7A. As shown in event record 732, the employee with ID of dhpotter caused the event with TIMECODE of 1 at 12:10:00 on 2005-1-1 for the reason of adding a new user (REASON of “add user”). New employee record 730 in employee table 502 has START set to 1, corresponding to TIMECODE from event record 732. In this embodiment, new telephone record 734 has START set to 1 because it happened during the same event as adding new employee record 730 to employee table 502. In addition, TIMECODE stored in DB global info table 704 is incremented by one to 1, ready for the next event to happen.

Further, new employee record 730 has END set to 999999. The TIMECODE of 999999 is a flag to indicate “end of time,” as shown in event table 702. “End of time” indicates that the data in the record is currently valid. Flags other than 999999 are possible, such as a nul. In this embodiment, new telephone record 734 has END set to 999999 because it is also currently valid.

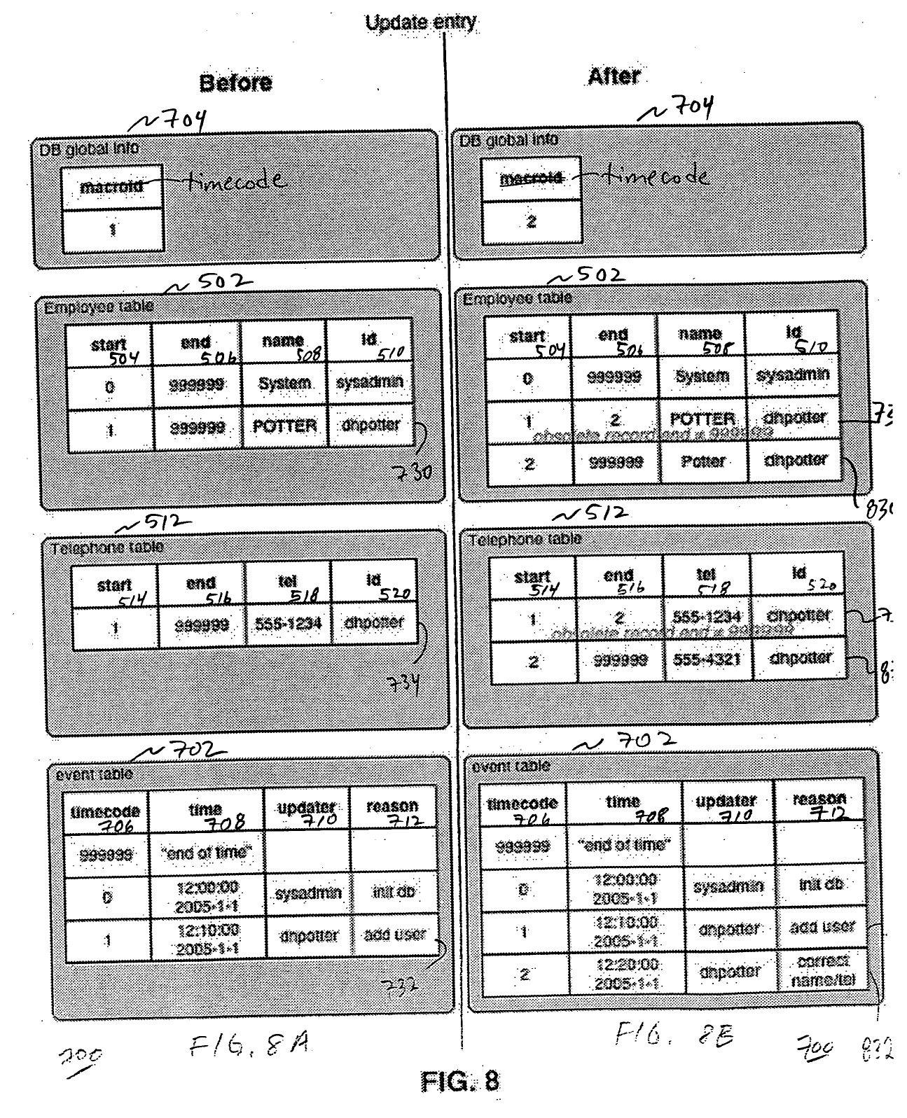

FIGS. 8A and 8B are block diagrams, consistent with this invention, of tables 502, 512, 702, 704 in database 700 before and after updating an entry in database 700. FIGS. 8A and 8B show employee table 502 and telephone table 512 as described in FIG. 5. FIGS. 8A and 8B also show DB global information table 704 and event table 702 as described in FIGS. 7A and 7B. Each table 704, 502, 512, 702 appears once in FIG. 8A and once in FIG. 8B. FIG. 8A shows the state of tables 704, 502, 512, and 702 before updating database 700. FIG. 8B is the sate of tables 704, 502, 512, and 702 after updating information in database 700.

After the event with TIMECODE of 1, Mr. Potter decides to (1) update telephone table 512 to indicate his correct telephone number and (2) change the case of the characters in his name. In this embodiment, an updated employee record 830 is added to employee table 502 with the updated information in (2) above and an updated telephone record 834 is added to telephone table 512 with updated information in (1) above. As shown in FIG. 8B, updated employee record 830 has a NAME of Potter and an ID of dhpotter. Updated telephone record 834, shown in FIG. 8B, has an ID of dhpotter and the correct TEL of 555-4321.

Event table 702 may describe the event of the change of employee record 730 and telephone record 734. In this embodiment, update event record 832 is added to event table 702. Update event record 832 is given a TIMECODE of 2, for example, because this is the next integer after the integer stored in DB global info table 704 in FIG. 8A. Update event record 832 indicates the event was caused by the employee with an ID of dhpotter at the TIME of 12:20:00 on 2005-1-1 for the purpose of correcting his name and telephone number (REASON of “correct name/tel”). In addition, TIMECODE stored in DB global info table 704 is incremented by one to 2, ready for the next event to happen.

Updated employee record 830 and updated telephone record 834 are assigned a START of 2, corresponding to TIMECODE 706 in update event record 834. Updated employee record 830 and updated telephone record 834 are assigned an END of 999999 indicating that the information stored in records 830 and 834 are current. Further, employee record 730 and telephone record 734 are assigned an END of 2, corresponding to the TIMECODE in update event record 834 that expired the data in records 730 and 734. Thus, employee record 730 is considered “expired” or “obsolete.”

New employee record 730 and updated employee record 830 form a “lineage.” A lineage may be identified by a LINEAGE ID field (not shown) in employee table 502 or by an attribute that would not change, such as employee ID attribute 510. For example, new employee record 730 and update employee record 830 may have a LINEAGE ID of 2, since new employee record 730 was the second new employee added to employee table 502. Further, a lineage may have several revisions that may be indicated by a REVISION field (not shown) in employee table 502, for example. New employee record 730 may have a REVISION of 1 and updated employee record 830 may have a REVISION of 2 since updated employee record 830 is the second record in the lineage. Further, updated employee record 830 may be considered the “successor” of new employee record 730. Likewise, new employee record 730 is the “predecessor” of updated employee record 830. A lineage, therefore, occurs when there is an obsolete or expired record with a successor.

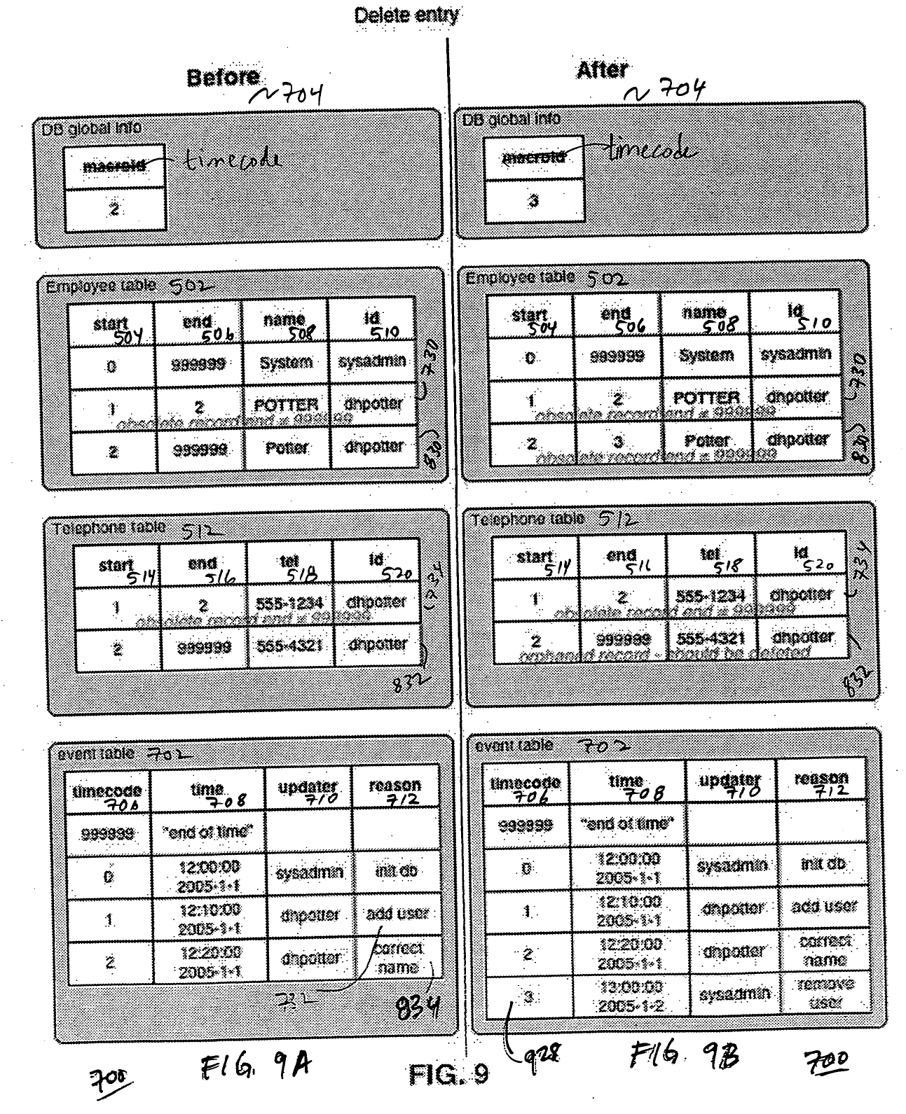

FIGS. 9A and 9B are block diagrams, consistent with this invention, of tables 502, 512, 702, 704 in database 700 before and after deleting an entry in database 700. FIGS. 9A and 9B show employee table 502 and telephone table 512 as described in FIG. 5. FIGS. 9A and 9B also show DB global information table 704 and event table 702 as described in FIGS. 7A and 7B. Each table 704, 502, 512, and 702 appears once in FIG. 9A and once in FIG. 9B. FIG. 9A shows the state of tables 704, 502, 512, and 702 before deleting a record in database 700. FIG. 9B shows the state of tables 704, 502, 512, and 702 after deleting a record in database 700.

After event timecode 2, the system administrator decides to remove Mr. Potter from employee table 502. As shown in event table 702 of FIG. 9B, a delete event record 928 is added to event table 702. Event table 702 may describe the event of deleting employee record 830 from employee table 502 in event record 928. Event record 928 indicates that the employee with ID of sysadmin caused the event at a TIME of 13:00:00 on 2005-2-1 for the purpose removing an employee (REASON of “remove user”). In this embodiment, event record 928 is given a TIMECODE of 3 because this is the next integer after the integer stored in DB global info table 704 in FIG. 9A. Updated employee record 830 is assigned an END of 3 in this embodiment because the record was deleted during the event corresponding to event record 928 with TIMECODE of 3. Because updated record 830 does not have an END of 999999, it has expired, has no successor in its lineage, and is thus “deleted.” TIMECODE 704 stored in DB global info table 704 is incremented by one to 3, ready for the next event to happen.

As explained above, a “current record,” in one embodiment, is a record that has an END attribute of 999999 (“end of time”). An “expired record,” in one embodiment, is a record that does not have an END of 999999. A “deleted lineage” is a lineage that does not have a current record. A “deleted record” is a record that is not current and does not have a successor. An “obsolete record,” in this embodiment, is a record that is not current but is not the last in its lineage. Note that “deleting” a record may not entail removing a record from a database but may entail adding information to the database.

FIG. 2 is a flow chart of a method 200 consistent with this invention. At step 202 a record is created for a time period, the record comprising an identifier and an attribute. Information is created indicative of a start time and an end time indicating when data in the attribute is valid for a time period comprising the current time (step 204). If the current record is updated or deleted (checked at step 206), the information at the time period is indicated as no longer current (step 208). If the record is being updated (not being deleted) (step 210), a new record is created (step 212), the new record comprising the identifier and the attribute comprising the updated data. New information indicative of a start and end time of a new time period is created comprising the current time, the indicator indicates a lineage (step 214).

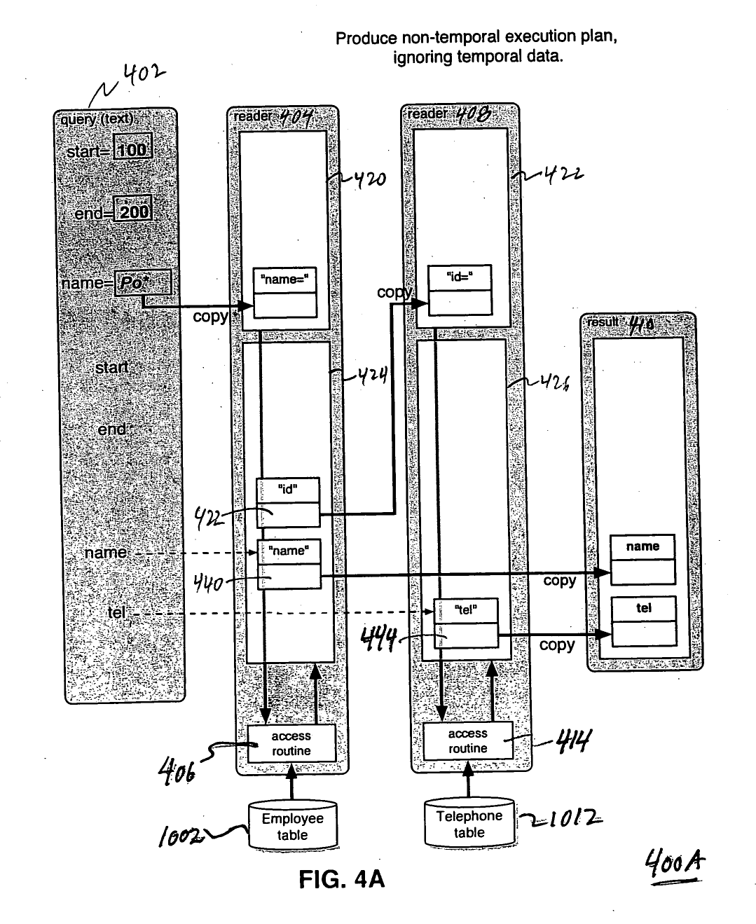

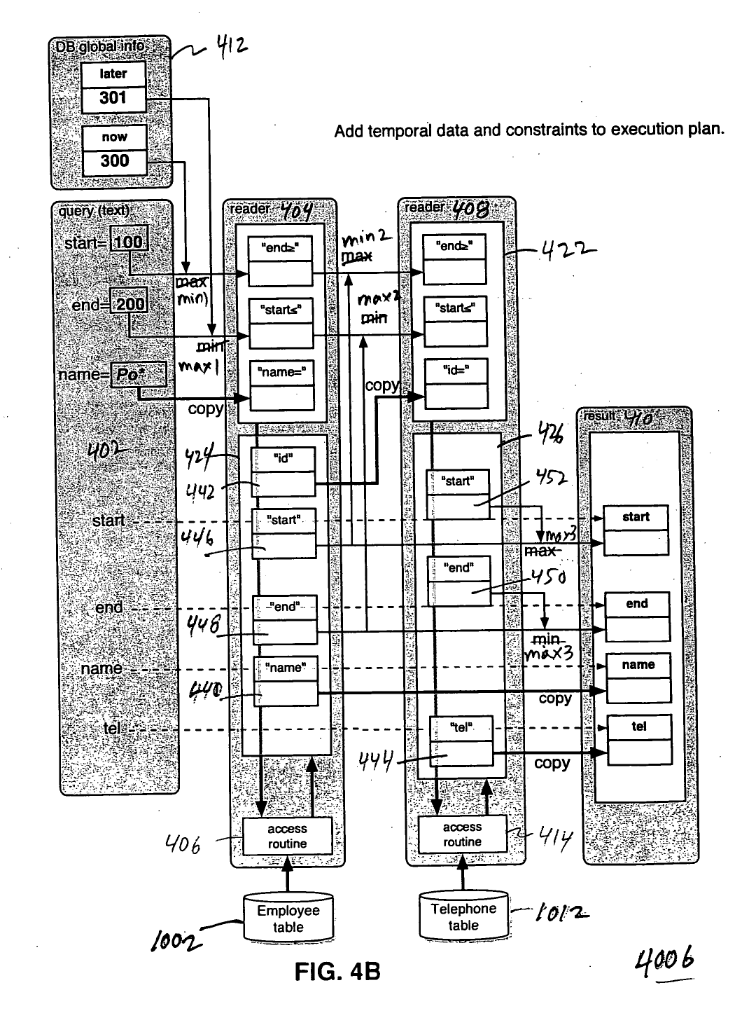

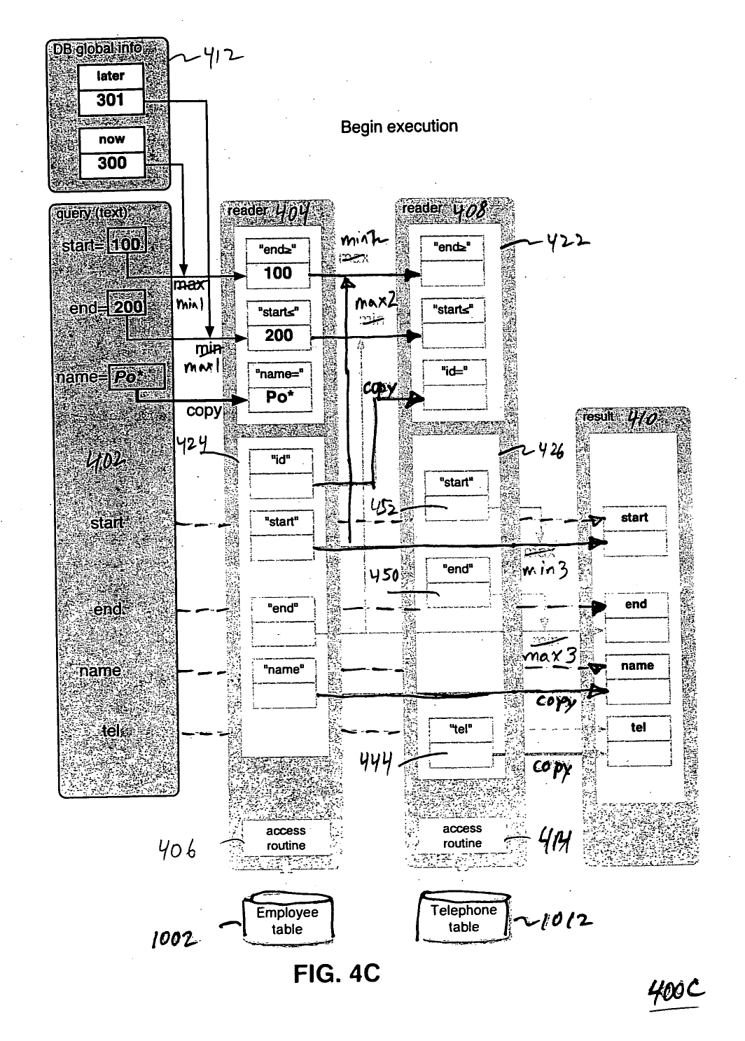

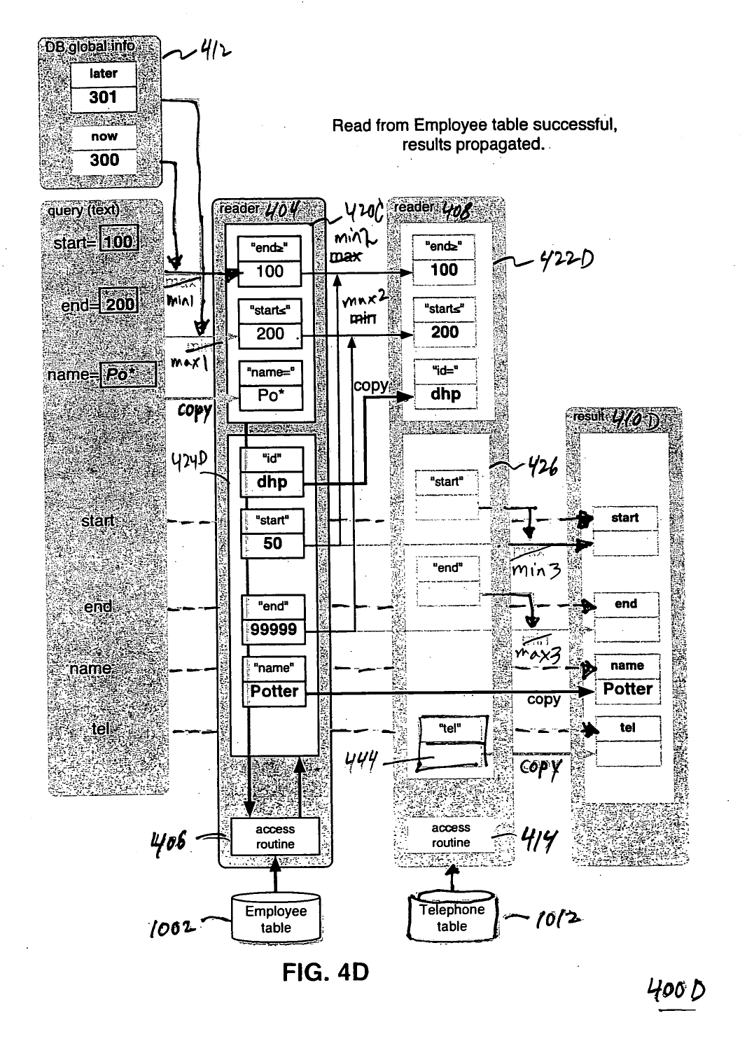

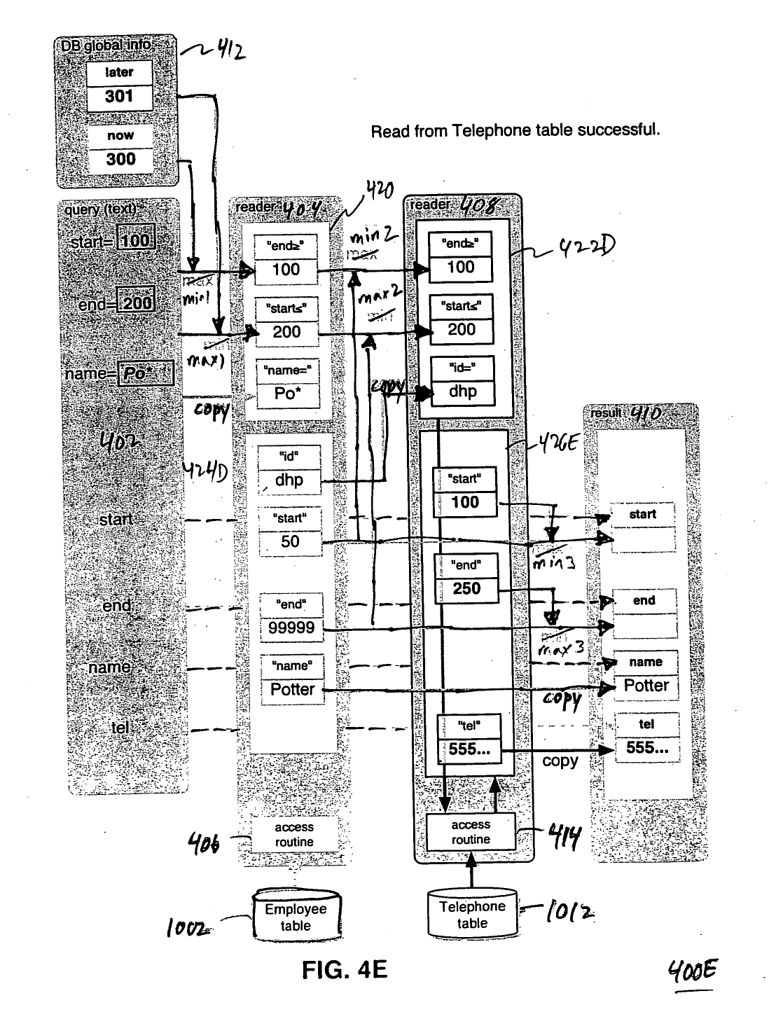

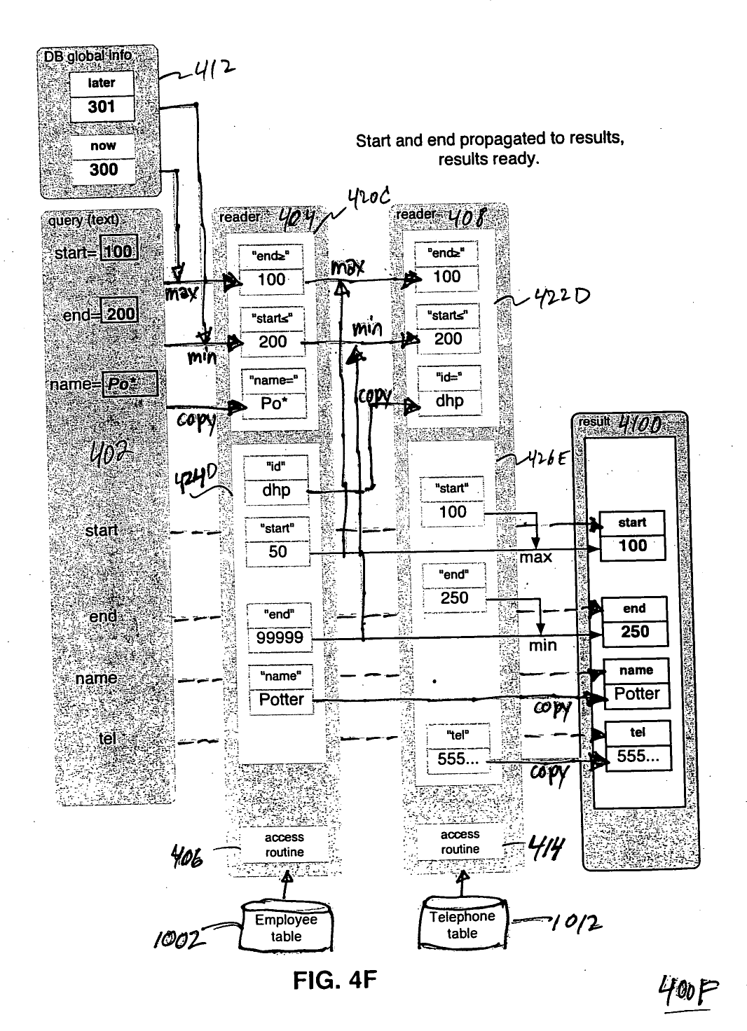

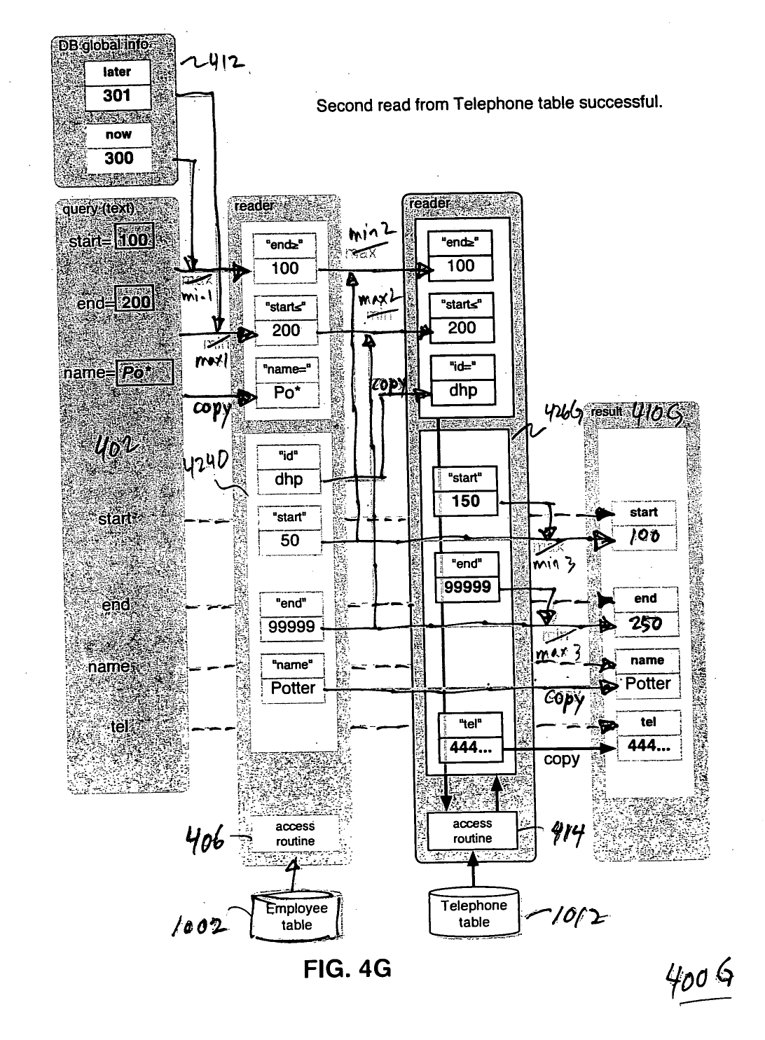

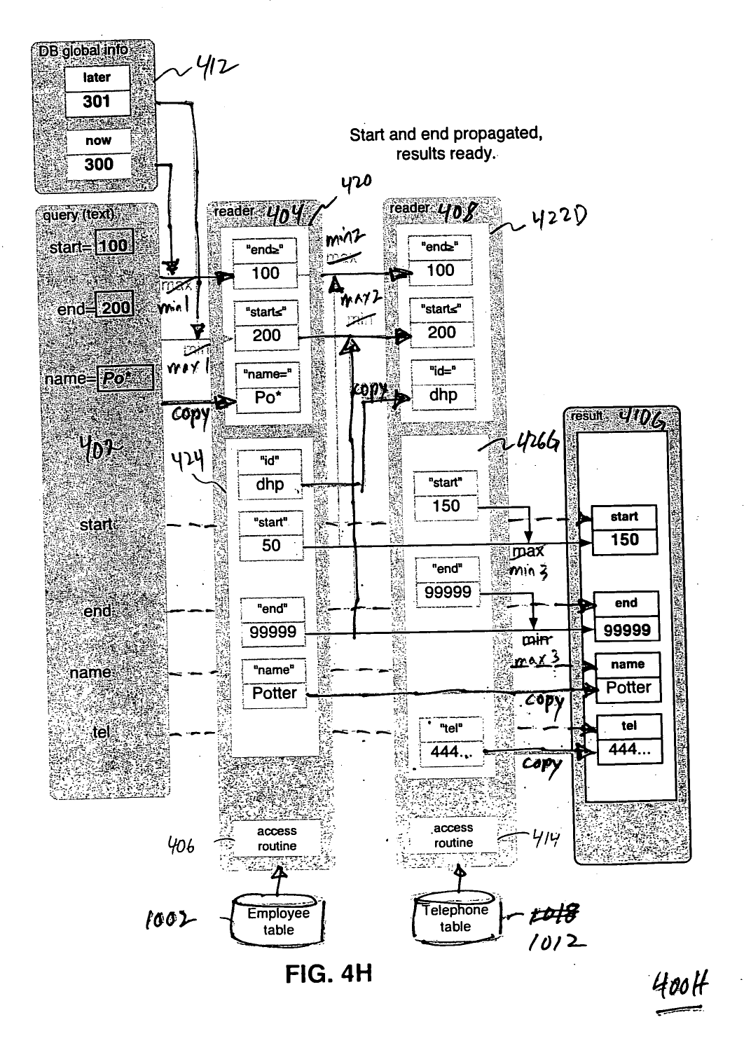

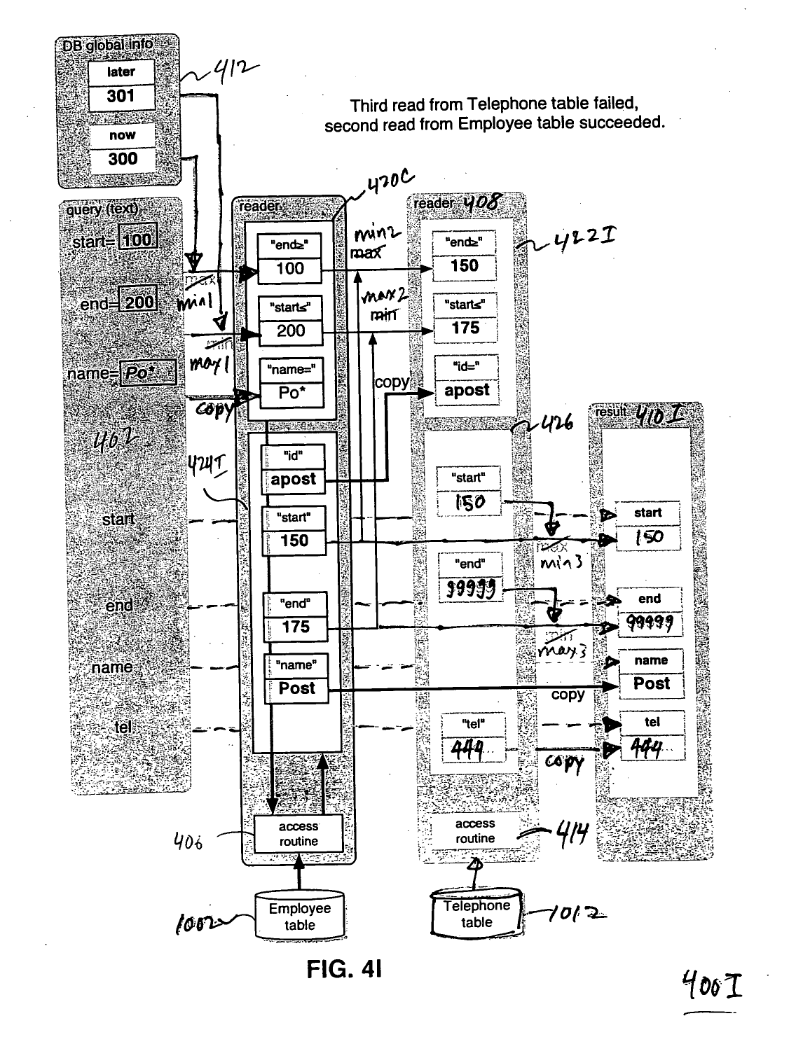

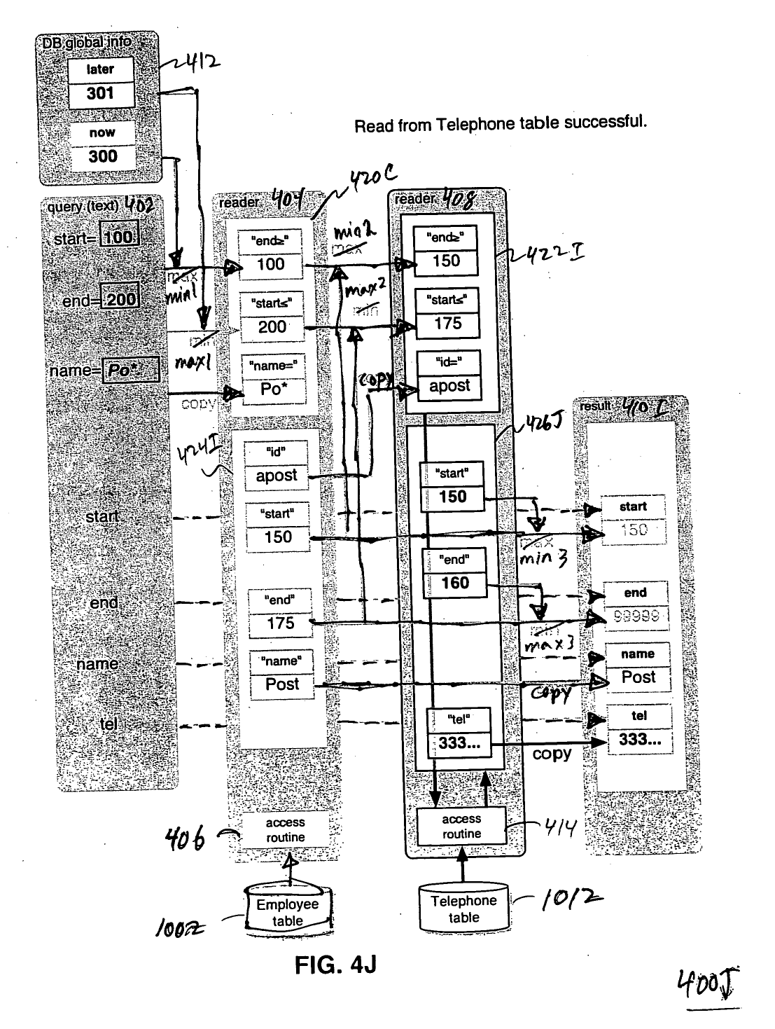

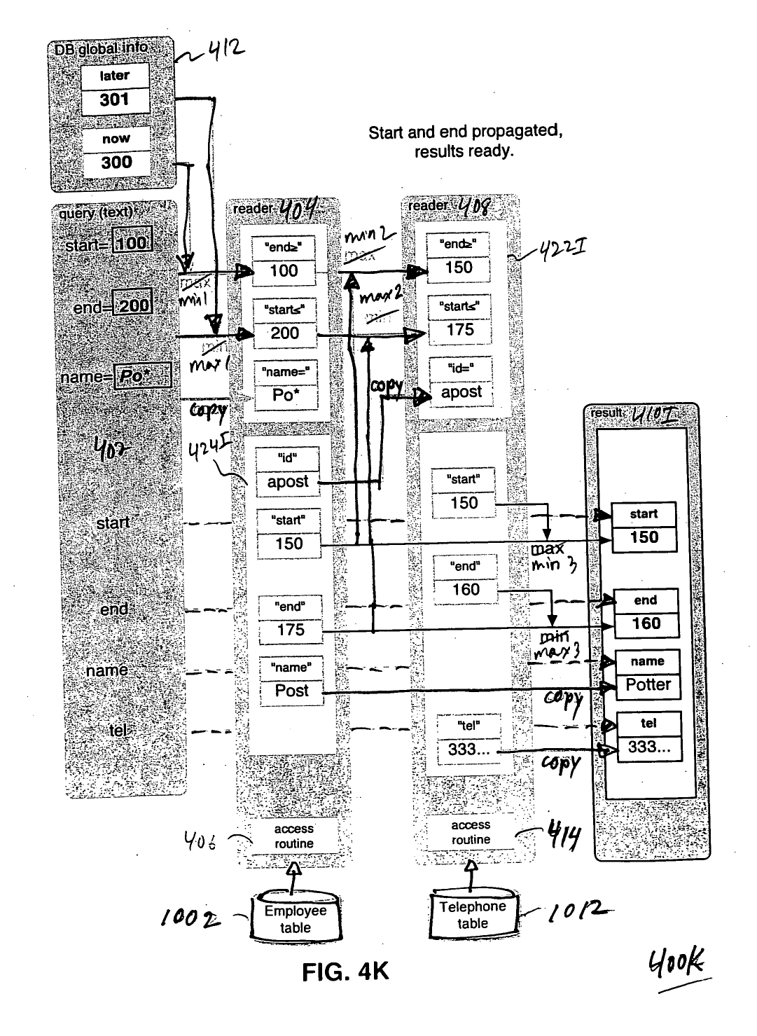

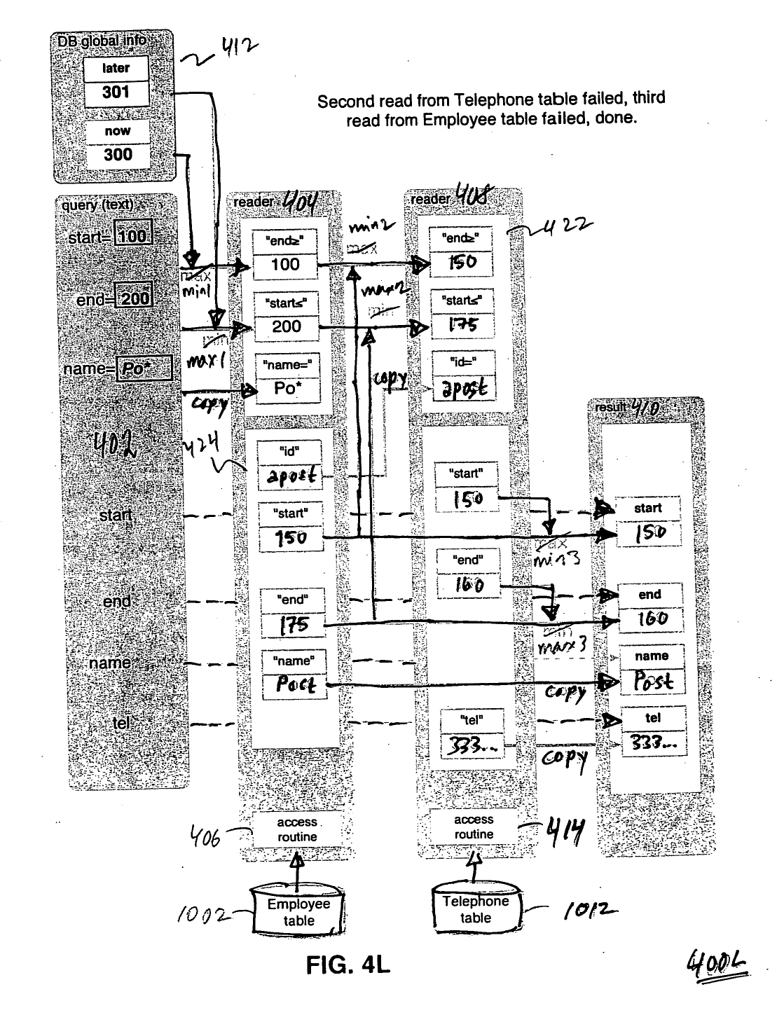

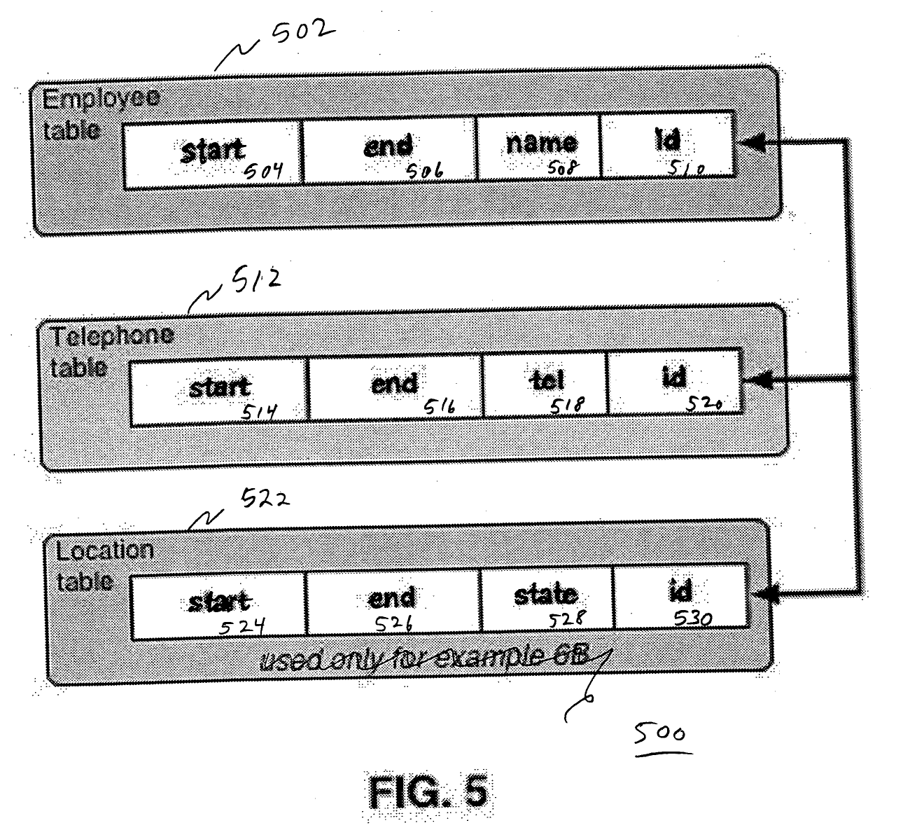

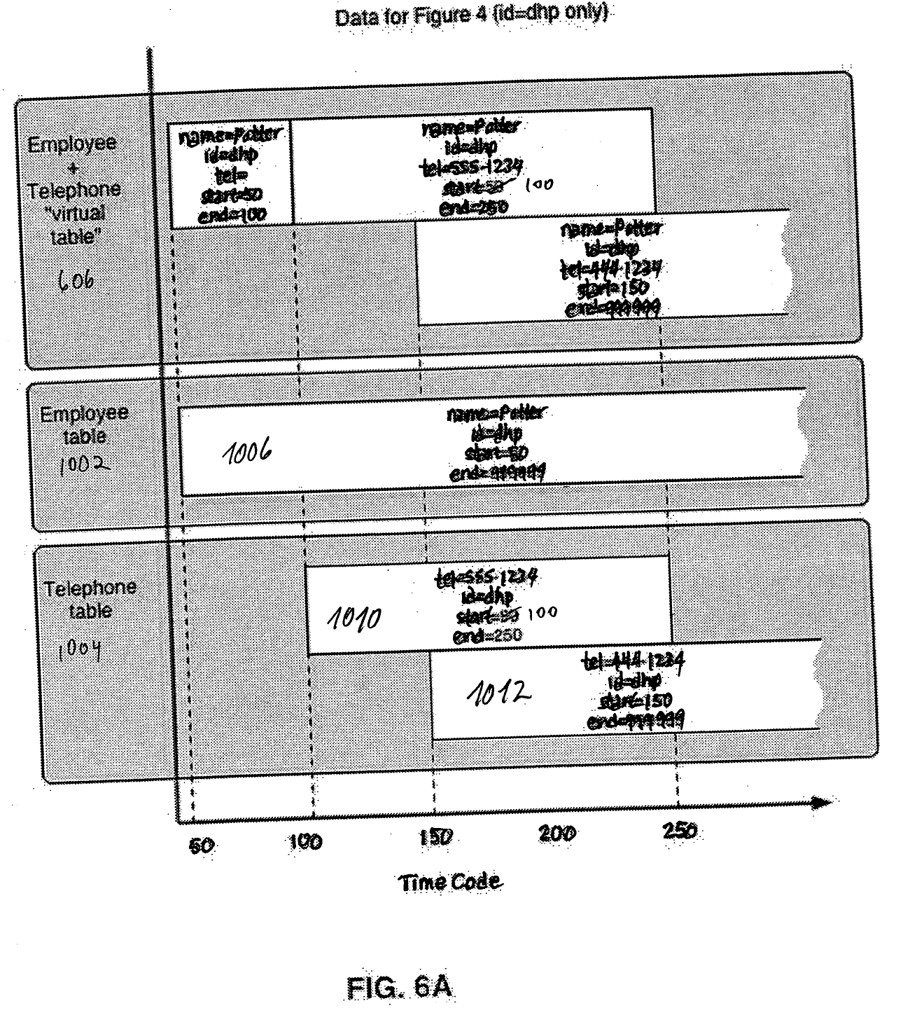

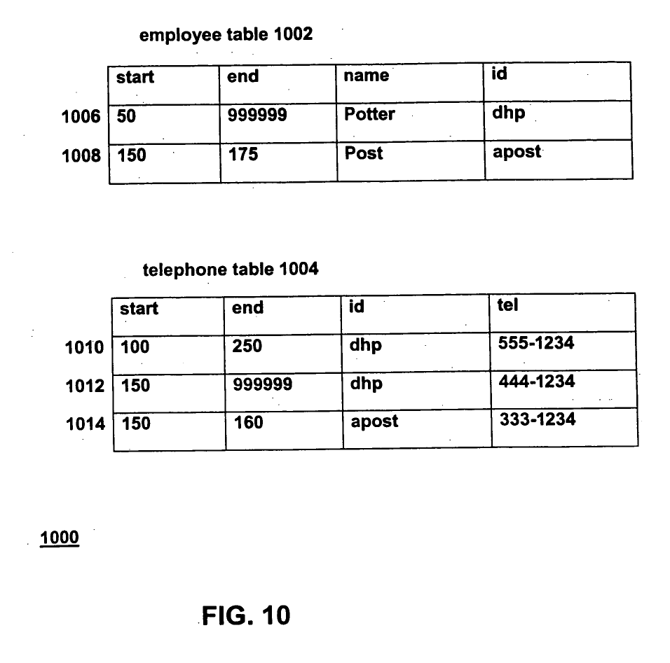

FIG. 4A through 4L (collectively FIG. 4) are a block diagrams, consistent with this invention, of query modules and data flow of a query execution. In FIG. 4, methods consistent with the invention generate a query execution plan 400 and execute the plan. Query 402 shown in FIG. 4 is: NAME=Po*, START=100, END=200, NAME, TEL, START, END. In other words, query 402 is to return the name and telephone of any employee with a name starting with “Po” existing in the database between timecode 100 (min timecode) and 200 (max timecode). Query 402 may also return the start and end timecode data of query 402 results. Query 402 may execute on data in database 1000 shown in FIG. 10.

FIG. 10 are block diagram of tables in a database 1000. Database 1000 comprises an employee table 1002 and a telephone table 1004. Employee table 1002 comprises two employee records 1006 and 1008. Telephone table 1004 comprises three telephone records 1010, 1012, and 1014. Neither employee table 1002 nor telephone table 1004, however, comprises both the attributes of NAME and TEL. In order to generate results of query 402, therefore, methods consistent with this invention “join” employee table 1002 and telephone table 1004 as defined by join-description file 109. For example, employee table 1002 and telephone table 1004 may be joined by the ID attribute, which is common to both tables 1002 and 1012.

FIG. 4A is a block diagram, consistent with this invention, of an execution plan 400A for query 402, but time restrictions are not considered at this time in this embodiment. In addition to query 402, execution plan 400A comprises a reader 404, a reader 408, and final results 410. Final results 410 are the results of query 402.

Reader module 404 comprises input conditions 420 and output results 424. Reader module 404 inputs the NAME=Po* condition and calls access routine 406, which has access to employee table 1002. After accessing employee table 1012, access routine 406 returns name attribute data 440 and id attribute data 442 that satisfy conditions 420 to output results 424. From output results 424, NAME attribute data 440 is output to final results module 410. ID attribute data 442 is output to reader module 408.

Reader module 408 comprises input conditions 422 and output results 426. Reader 408 receives ID attribute data 440 in input conditions 422 from reader 404. Reader module 408 calls access routine 414, which has access to telephone table 1012. Access routine 414 accesses telephone table 1012 and returns TEL attribute data 444 that satisfy input conditions 422. TEL attribute data 444 is output to final results module 410. Execution plan 400A may be executed a record at a time on employee table 1002 by reader 404 and a record at a time on telephone table 1012 by reader 408.

FIG. 4B is a block diagram, consistent with this invention, of an execution plan 400B with time limitations added. To determine whether a record was valid during a particular time period, where the period is bound by min timecode and max timecode, a comparison is made to determine whether a record's end is greater than or equal to the max timecode and if the record's start is less than or equal to the min timecode. Thus, input conditions 420 in reader 404 are “END>=min1” and “START<=max1”. Min1 and max1 may be identical to min timecode (100) and max timecode (200) defined by query 402, respectively. Min1 or max1, however, may be adjusted according to the current time stored in DB global info 412 in the NOW attribute and the LATER attribute. For example, if the min timecode provided by query 402 is greater than NOW timecode stored in DB global info 412, then min1 may be adjusted to the NOW timecode stored in DB global info 412. Further, if the max timecode provided by query 402 is greater than LATER timecode stored in DB global info 412, then max1 may be adjusted to the LATER timecode stored in DB global info 412.

Input conditions 422 in reader 408 are “END>=min2” and “START<=max2”. As discussed above with respect to FIG. 4A, ID attribute data 442 is copied to reader 408 so that reader 408 may query telephone table 1012. Likewise, respective START attribute data 446 and END attribute data 448 may be copied to reader 408 and become min2 and max2, respectively. Min2 or max2 may be adjusted, however, according to the min1 and max1 because query 402 is not concerned about time periods outside min1 and max1, for example. In one embodiment, min2 and max2 are the intersecting set of [min1, max1] and [START, END] attribute data 446 and 448. In other words, min2 and max2 become the most restrictive time period defined by min1, start attribute data 446, max2, and end attribute data 448.

As discussed above, access routine 414 returns TEL attribute data 444. Access routine also returns corresponding END attribute data 450 and START attribute data 452. The START and END attribute data 450, 452 may be output to results 410 as min3 and max3. Min3 or max3 may be adjusted, however, according to the corresponding START attribute data 446 and END attribute data 448 from reader 404. In one embodiment, min3 and max3 are the intersecting set of [START, END] attribute data 446 and 448 and [START, END] attribute data 450 and 452.

FIG. 4C is a block diagram of the execution of execution plan 400B with time limitations on database 1000 of FIG. 10. As shown in FIG. 4C, min timecode (100) and max timecode (200) are copied through to input conditions 420 as min1 and max1. The condition name=Po* is copied through to conditions 420. The conditions for reader 404 are: (1) END>=100; AND (2) START<=200; AND (3) NAME=Po*. FIG. 4D shows a continuation of the execution of plan 400B. In FIG. 4D, access routine 406 accesses employee table 1002 and retrieves the first record that satisfies conditions 420C and outputs results 424D. The first record that satisfies conditions 420C (and output to results 424D) is employee record 1006 in employee table 1002. Employee record 1006 has an ID of dhp, START of 50, END of 999999, and NAME of Potter. ID attribute of dhp is copied from reader 404 to reader 408 as part of conditions 422D for reader 408. START of 50 is outside the range of min1 (100) and max1 (200). As a result, the min1 (100) is copied through to conditions 422D in reader 408 as min2. END of 999999 is also outside the range of min1 and max1. As a result, the max1 (200) is copied through to conditions 422D in reader 408 as max2.

In FIG. 4E, shows a continuation of the execution of plan 400B. Reader 408 calls access routine 414. Access routine applies conditions 422D and outputs results 426E. The first record that satisfies conditions 422D (and output to results 426E) is telephone record 1010. Telephone record 1010 has TEL of 555-1234, which is output to final results 410. Telephone record 1010 has a START of 100 and an END of 250, which is more restrictive than the start of 50 and end of 999999 in output results 424D. Therefore, final results 410 is passed a START timecode of 100 as min3 and an END timecode of 250 as max3, which is the intersection of results 424D and 426E.

After results 426E shown in FIG. 4F are passed to results 410D, access routine 414 continues to search telephone table 1012 for records that meet conditions 422D. The next record in table 1012 that satisfies conditions 422D is record 1012 with START of 150, END of 999999, ID of dhp, and TEL of 444-1234. As shown in FIG. 4G, results 426G reflect record 1012. The TEL attribute data is output to results 410G. As shown in FIG. 4H, the most restrictive time from results 424D and results 426G is output to final results 410G as min3 and max3. Therefore, final results 410G in FIG. 4H shows a START of 150 and an END of 200.

As shown in FIG. 41, there are no more records in telephone table 1012 left that met the criteria 422D for employee dhp. Therefore, access routine 406 finds the next record in employee table 1002 that meets criteria 420C, namely record 1008 with START of 150, END of 175, name of Post and id of apost. Result 424I found reflects record 1008. Result 424I has a more restrictive time period than min1 and max1. Therefore, the time period in results 424I is passed to conditions 422I in reader 404 as min2 and max2. The ID attribute data of apost is also passed from result 424I to conditions 422I in reader 408. Further, a name of Post from results 424I is passed to final results 410I.

As shown in FIG. 4J, reader 408 calls access routine 414 to access telephone database 1012. Access routine returns telephone record 1014, which satisfies conditions 422I. Access routine 414 returns record results 426J, including a TEL of 333-1234, which is passed to final results 410. As shown in FIG. 4K, results 426J has a time period from a START of 150 to an END of 160. This is more restrictive than the time period in results 424I. Therefore, time period in results 426J is passed to final results 410 as min3 and max3.

As shown in FIG. 4L, there are no more records that satisfy conditions 422I, conditions 422D, or conditions 420C. Therefore, query 402 is complete and execution plan 400B stops. Employee table 1002 and telephone table 1004 could, in another example, comprise more records that do not satisfy conditions of the query and provide the same final results 410.

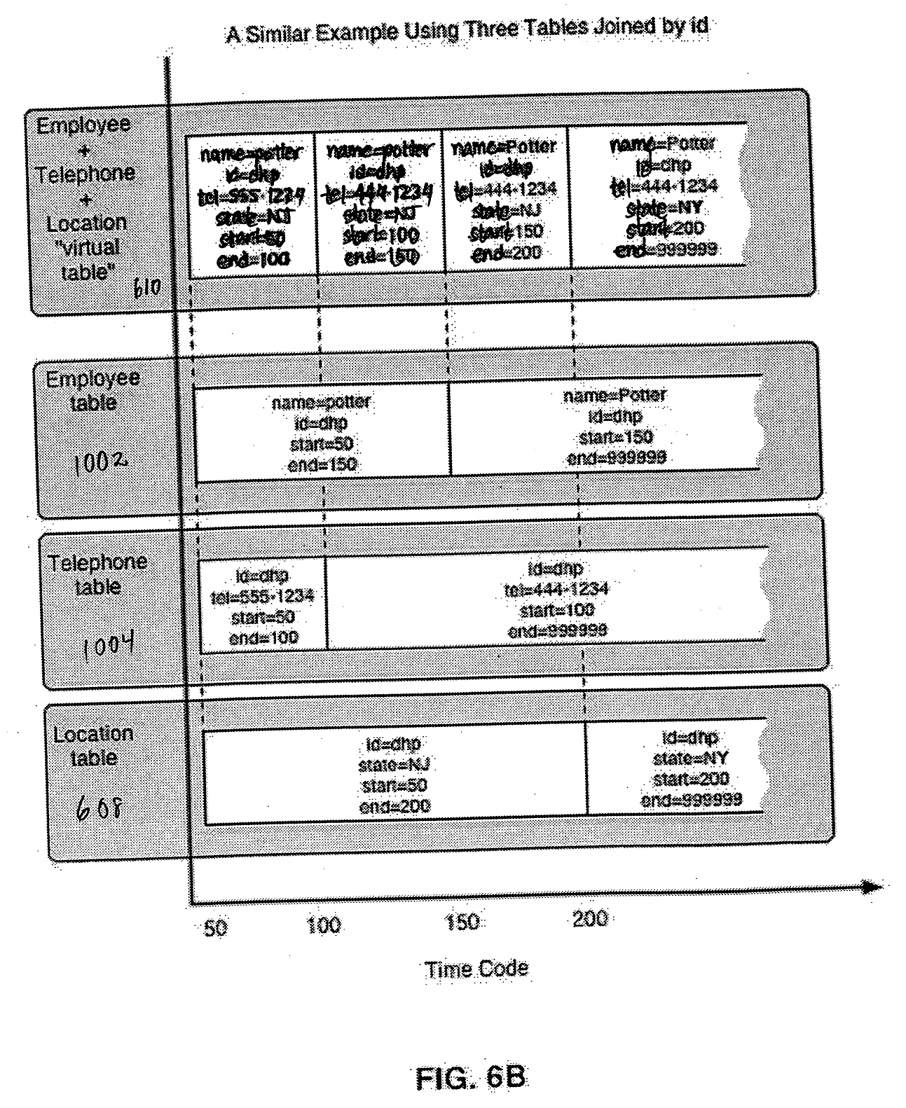

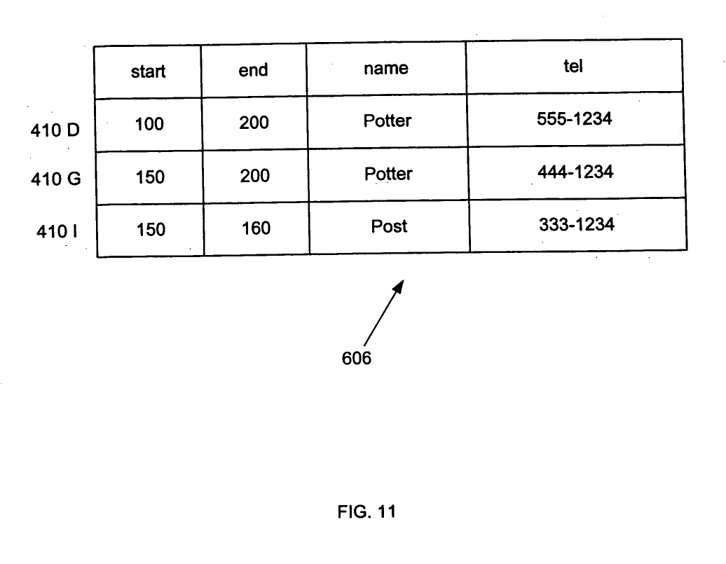

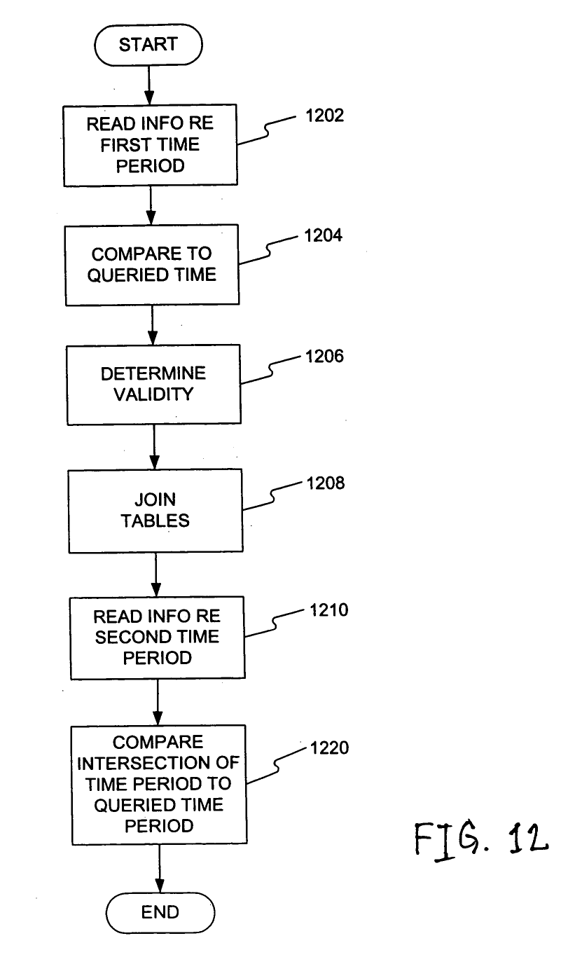

FIG. 6A is a timeline, consistent with this invention, of employee table 1002 and telephone table 1004 for records with ID=dhp. As shown in FIG. 6A, the only record 1006 with ID=dhp has a START of 50 and an END of 999999. As shown in FIG. 6A, two records exist in telephone table 1004 with ID=dhp. The earlier record 1010 has a START of 100 and an END of 250. The later record 1012 has a START of 150 and an END of 999999. FIG. 6A also shows a “virtual table” 606 that may not exist in its entirety at any given time in database 1000. Virtual table 606 is the join of employee table 1002 and telephone table 1004. Virtual table also appears in FIG. 11. FIG. 11 is an example of a virtual table consistent with this invention. FIG. 6B is a timeline, consistent with this invention, of employee table 1002, telephone table 1004, and location table 608. The three tables 1002, 1004, and 608 may be jointed to form an employee+telephone+location “virtual table” 610.

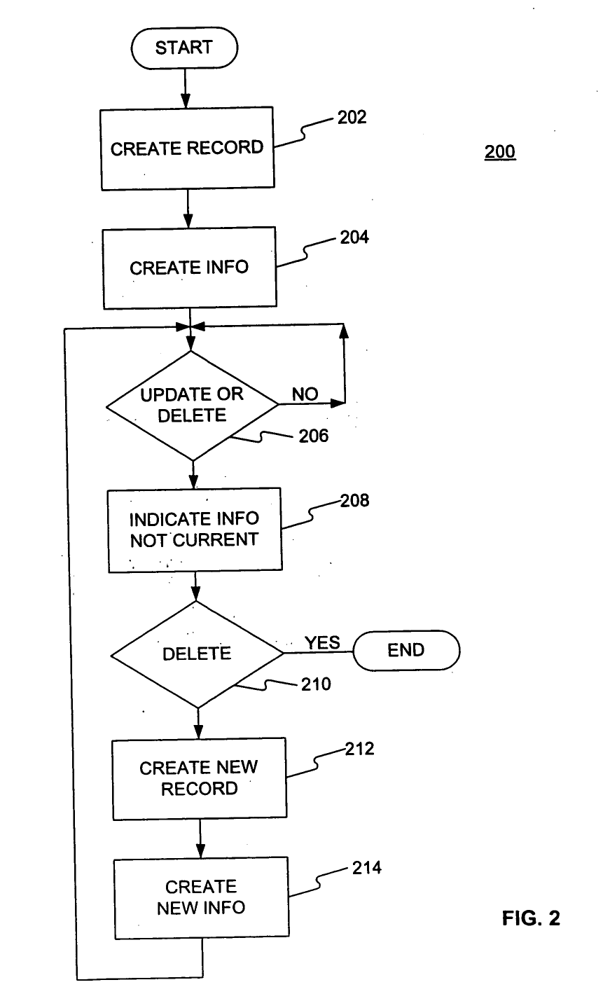

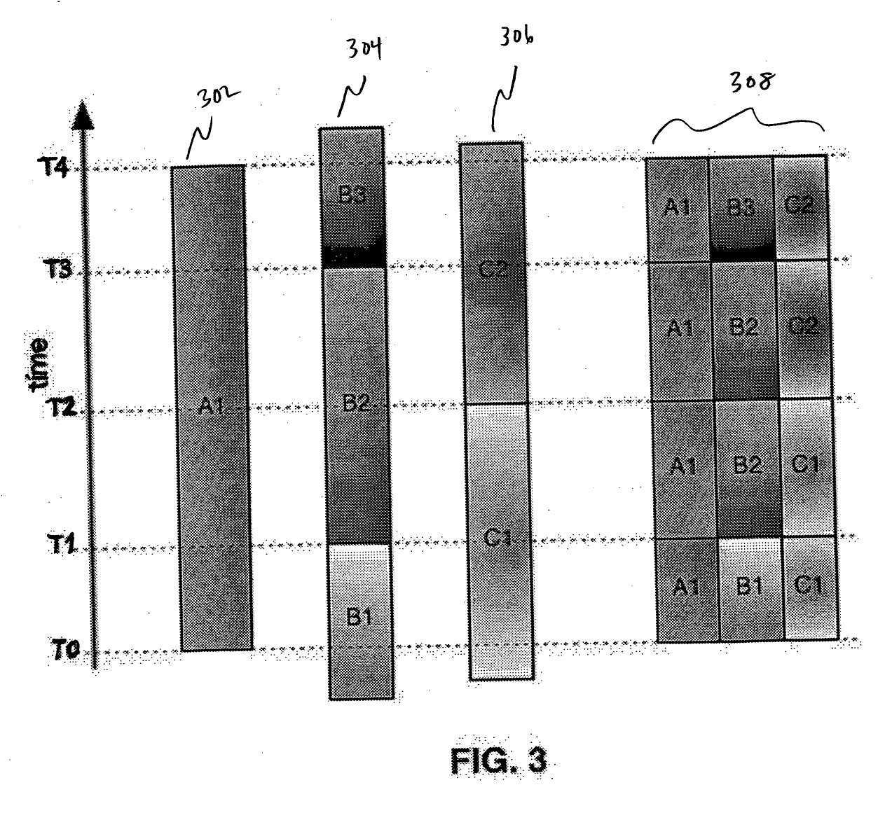

FIG. 3 is a timeline of three tables consistent with this invention. Table A 302 is unchanged (A1) from time T0 to time T4. Table B 304 has three values: B1 from time T0− to time T1; B2 from time T1 to time T3; and B3 from time T3 to time T4+. Table C 306 has two values: Cl from time T0− to time T2; and time C2 from time T2 to time T4+. According to this invention, tables A 302, B 304, and C 306 can be joined into a “virtual table” 308.

A database program may create execution plan 400 and execute execution plan 400. FIG. 12 is a flow diagram of a method consistent with this invention for querying a database. Methods and systems consistent with this invention search a database for valid attribute data at a queried time period. A method or system consistent with this invention read information indicative of a particular time period of a record, wherein the record satisfies a condition and wherein the particular time period has a start time and an end time (step 1202). The particular time period is compared to the queried time, wherein the queried time period has a start and end period (step 1204). Data in an attribute of the record is determined valid at the queried time depending on the results of comparing the particular time period to the queried time (step 1206). The database may comprise a first and second table, wherein the first table comprises the record. The first and second tables may be joined by a joined attribute (step 1208). Information indicative of a second particular time period of a second record is read, wherein the second table comprises the second record and wherein the second particular time period comprises a start and an end time (step 1210). The intersection of the particular time period and the second particular time period is compared to the queried time period (step 1212).

Other embodiments of the invention are apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for updating a record comprising an attribute in a database, the method comprising:
updating information associated with the record, wherein the information is indicative of an end time of the record and indicates that the record has expired;
creating a new record and new information associated with the new record, wherein the new information is indicative of a start time, and wherein the new record comprises the attribute of the expired record; and
writing updated data to the attribute in the new record;

2. The method of claim 1, wherein the information indicative of an end time indicates that the record has expired, and wherein the new information associated with the new record indicates that the new record is current.

3. The method of 1, wherein the information indicative of an end time is associated with an event comprising the end time.

4. The method of claim 3, wherein the event identifies a user causing the event.

5. The method of claim 4, wherein the event identifies a reason for the event.

6. A computer-readable memory device having a computer program with instructions for creating a data structure for a database, the data structure comprising:
a first record for a first time period comprising
an identifier, and
an attribute;
a second record for a second time period comprising
the identifier, and
the attribute;
first information indicative of a start time and an end time of the first time period, wherein data in the attribute in the first record is valid for the first time period; and
second information indicative of a start time and an end time of the second time period, wherein data in the attribute in the second record is valid for the second time period.

7. The computer-readable memory device of claim 6, wherein the database is configured for a query program to determine valid data at a queried time by analyzing the first and second information.

8. The computer-readable memory device of claim 7, wherein data in the attribute in the record for the first time period is not known to be valid for time outside the first time period and wherein data in the attribute in the record for the second time period is not known to be valid for time outside the second time period.

9. A method for searching a database for valid attribute data at a queried time period the method comprising:
reading information indicative of a first time period of a record, wherein the record satisfies a condition and wherein the first time period has a start time and an end time;
comparing the first time period to the queried time, wherein the queried time period has a start and end period;
determining whether data in an attribute of the record is valid at the queried time depending on the results of comparing the first time period to the queried time; and
repeating reading, comparing, and determining on a plurality of records in the database.

10. The method of claim 9, wherein the database comprises a first and second table, wherein the first table comprises the record, the method comprising
joining the first and second tables by a joined attribute;
reading information indicative of a second time period of a second record, wherein the second table comprises the second record and wherein the second time period comprises a start and an end time;
comparing the intersection of the first time period and the second time period to the queried time period.

11. A method for storing data in a database, the method comprising:
creating a record for a first time period, the record comprising an identifier and an attribute;
creating a record for a second time period comprising, the record comprising the identifier and the attribute;
creating first information indicative of a start time and an end time of the first time period, wherein data in the attribute is valid for the first time period, and second information indicative of a start time and an end time of the second time period, wherein data in the attribute is valid for the second time period.

12. The method of claim 11, wherein the identifier indicates a lineage.

13. The method of claim 12, including deleting a record by indicating in the second information that the second time period is not current.

14. The method of claim 12, including updating a record by
indicating in the first information that the first time period is not current;
indicating in the second information that the second time period is current; and
updating the attribute data in the record for the second time period.

15. A computer-readable medium comprising instructions for forming a database, the method comprising:
updating information associated with the record, wherein the information is indicative of an end time of the record and indicates that the record has expired;
creating a new record and new information associated with the new record, wherein the new information is indicative of a start time, wherein the new record comprises the attribute of the expired record;
writing updated data to the attribute in the new record;

16. The computer-readable medium of claim 15, wherein the information indicative of an end time indicates that the record has expired; and wherein the new information associated with the new record indicates that the new record is current.

17. The computer-readable medium of claim 14, wherein the information indicative of an end time is associated with an event comprising the end time.

18. The computer-readable medium of claim 17, wherein the event identifies an identification of a user causing the event.

19. The computer-readable medium of claim 18, wherein the event identifies a reason for the event.
